(19) United States
(12) Patent Application Publication
(10) Pub. No.: US 2022/0225074 A1
(43) Pub. Date: Jul. 14, 2022

(54) MOBILE COMMUNICATION NETWORK ARRANGEMENT AND METHOD FOR OPERATING A MOBILE COMMUNICATION NETWORK ARRANGEMENT TO SUPPORT INTER-CORE NETWORK ROAMING

(71) Applicant: NTT DOCOMO, INC., Tokyo (JP)

(72) Inventors: Malla Reddy Sama, Munich (DE); Jari Mutikainen, Munich (DE); Srisakul Thakolsri, Munich (DE); Atsushi Minokuchi, Tokyo (JP)

(73) Assignee: NTT DOCOMO, INC., Tokyo (JP)

(21) Appl. No.: 17/608,642

(22) PCT Filed: May 5, 2020
(86) PCT No.: PCT/EP2020/062400

§ 371 Date: Nov. 3, 2021

(30) Foreign Application Priority Data
May 10, 2019 (EP) 19173865.7

(51) Int. Cl. H04W 8/12; H04W 8/04; H04W 8/06

(52) U.S. Cl. CPC H04W 8/12; H04W 84/042; H04W 8/06; H04W 8/04

(57) ABSTRACT

According to one embodiment, a server device includes one or more processors. The one or more processors are configured to identify a home mobile network of a user equipment that attempts to roam in a visited mobile network including the server device, send, to a network function repository function, a service request that identifies the home mobile network, receive, from the network function repository function, a service request response that identifies a home subscriber service in the home mobile network and that identifies the home mobile network as a legacy network of the visited mobile network, retrieve, from the home subscriber service, subscriber information for the user equipment, and configure a roaming connection for the user equipment in the visiting mobile network.

The present disclosure relates to mobile communication network arrangements and methods for operating a mobile communication network arrangement to support inter-core network roaming.

Many network operators have begun planning to deploy Fifth Generation (5G) mobile networks. As with their Fourth Generation (4G) Long Term Evolution (LTE) technology, the 3^{rd} Generation Partnership Project (3GPP) has proposed their own 5G technology. The 3GPP is currently defining both a 5G core network—5GC—and a 5G radio access technology—5G New Radio (NR).

The 3GPP has proposed various options for mobile network operators to deploy their 3GPP 5G technologies, many of which integrate both 4G and 5G components to provide radio access to users. It is expected that mobile network operators will select between the various available 3GPP options as they gradually deploy more 5G technologies across their respective networks.

While different 4G and 5G integration options may help expedite 5G deployment, the interworking between 4G and 5G networks may complicate certain operations. One such operation is roaming. Traditionally, a user equipment (UE) uses roaming to operate on a mobile network that is not its home network. Because the UE is not on its home network (Home Public Land Mobile Network (HPLMN)), the visited mobile network (Visited Public Land Mobile Network (VPLMN), also called the serving network) needs to interface with the home mobile network to verify the UE's subscriber information and, if applicable, set up a data connection via the HPLMN.

This roaming procedure has been fully developed for legacy networks as well as some configurations for 5G. The 3GPP, however, has not provided solutions for all 5G deployment options. Thus, mobile network operators may desire new solutions that can support roaming even for complex 5G deployment configurations.

According to one embodiment, a server device includes one or more processors. The one or more processors are configured to identify a home mobile network of a user equipment that attempts to roam in a visited mobile network including the server device, send, to a network function repository function, a service request that identifies the home mobile network, receive, from the network function repository function, a service request response that identifies a home subscriber service in the home mobile network and that identifies the home mobile network as a legacy network of the visited mobile network, retrieve, from the home subscriber service, subscriber information for the user equipment, and configure a roaming connection for the user equipment in the visiting mobile network.

In the drawings, like reference characters generally refer to the same parts throughout the different views. The drawings are not necessarily to scale, emphasis instead generally being placed upon illustrating the principles of the invention. In the following description, various aspects are described with reference to the following drawings, in which:

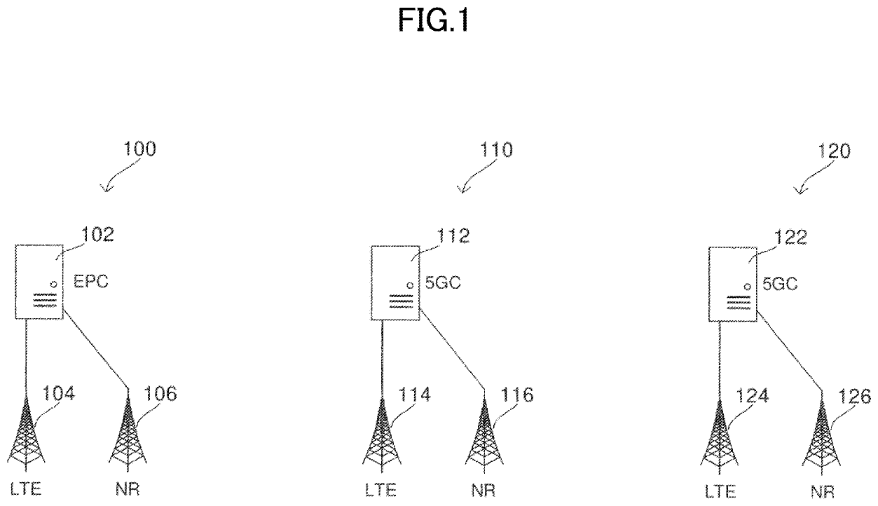

FIG. 1 illustrates several non-standalone options for deploying 5G NR with 4G LTE.

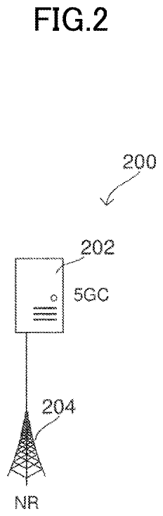

FIG. 2 illustrates a standalone option for deploying 5G NR.

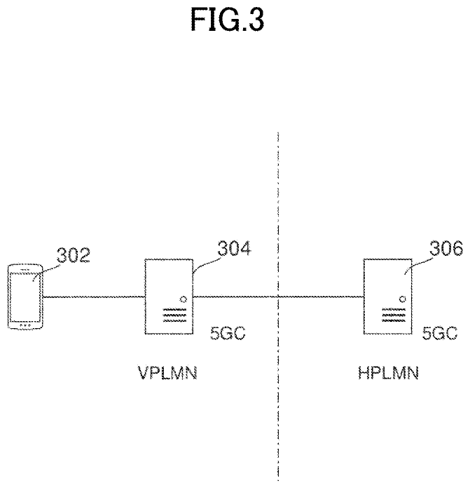

FIG. 3 illustrates roaming between a 5GC VPLMN and 5GC HPLMN.

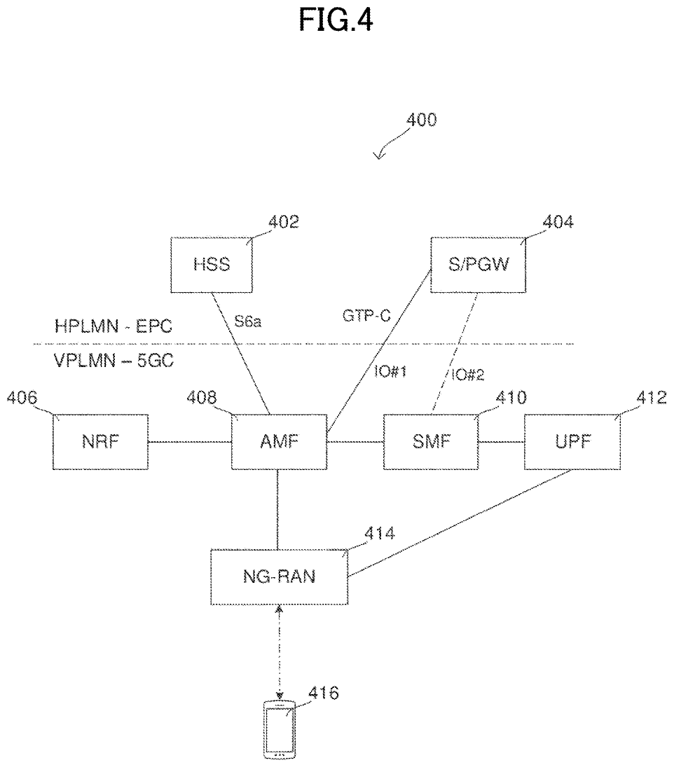

FIG. 4 illustrates a network diagram showing inter-core network roaming between a 5GC VPLMN and an EPC HPLMN.

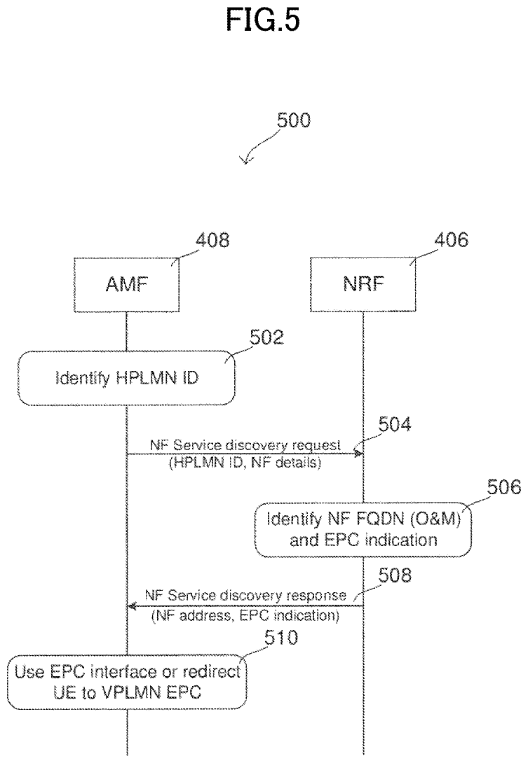

FIG. 5 illustrates a general message sequence chart for an AMF to discover EPC NFs with an NRF.

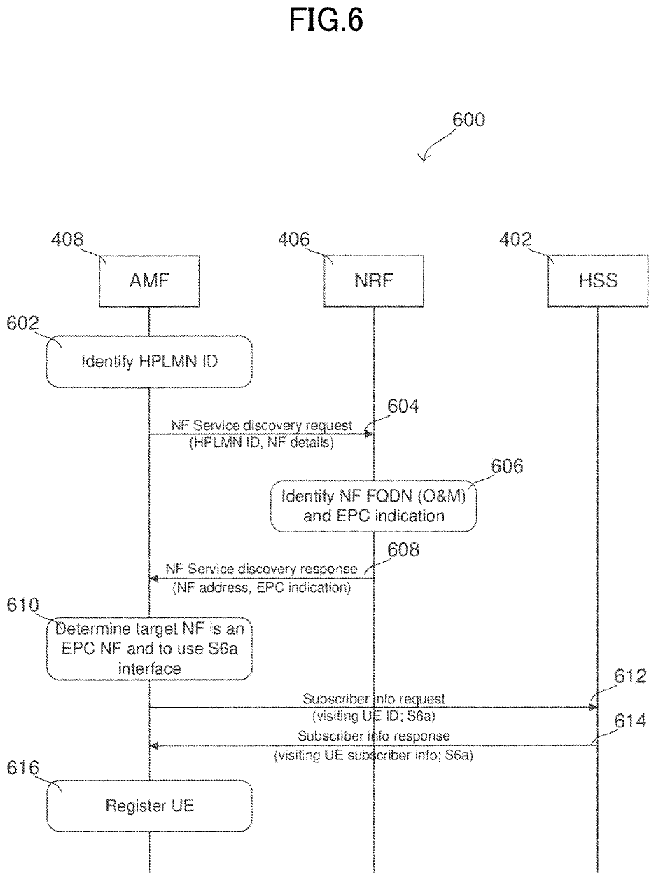

FIG. 6 illustrates a message sequence chart for inter-core network roaming where an AMF discovers an EPC HSS, requests subscriber information for a visiting UE from the HSS, and attaches the visiting UE for a roaming connection.

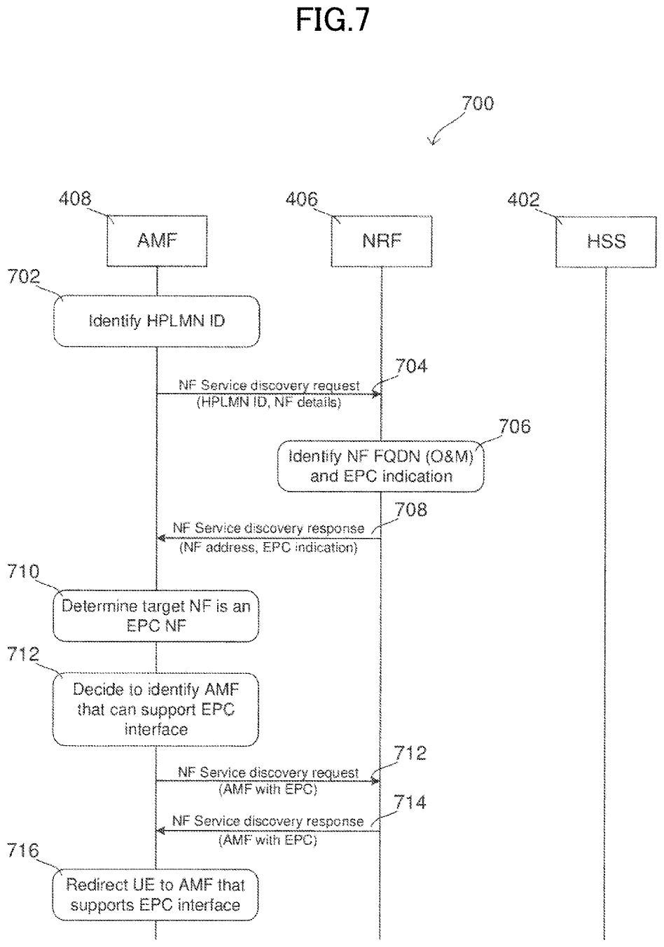

FIG. 7 illustrates a message sequence chart for inter-core network roaming where an AMF redirects a visiting UE to another AMF that can configure an inter-core network roaming connection for the visiting UE.

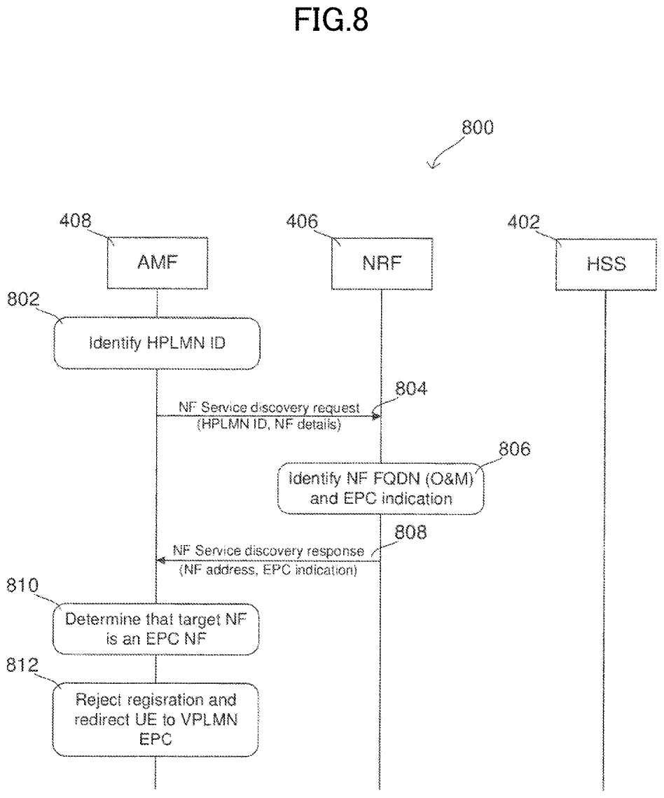

FIG. 8 illustrates a message sequence chart for inter-core network roaming where an AMF rejects a visiting UE's attach (Registration) request and redirects the visiting UE to the VPLMN EPC.

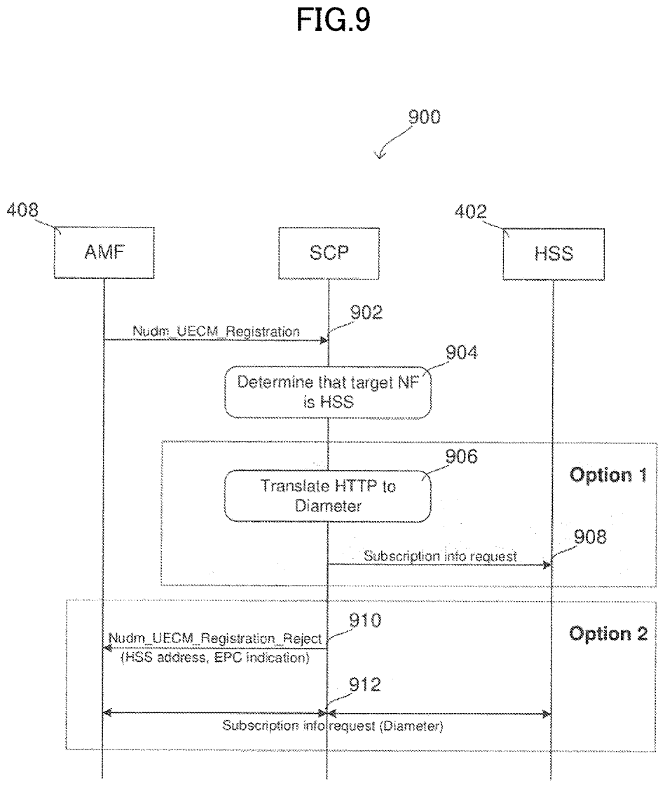

FIG. 9 illustrates a message sequence chart where an AMF discovers an EPC HSS with an SCP.

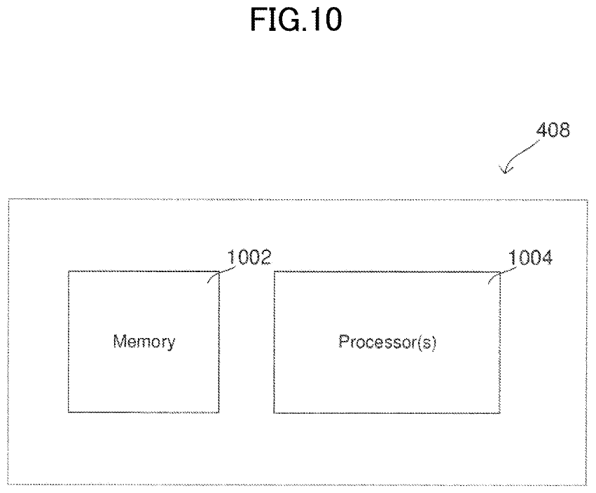

FIG. 10 illustrates an internal configuration of an AMF.

The following detailed description refers to the accompanying drawings that show, by way of illustration, specific details and aspects of this disclosure in which the invention may be practiced. Other aspects may be utilized and structural, logical, and electrical changes may be made without departing from the scope of the invention. The various aspects of this disclosure are not necessarily mutually exclusive, as some aspects of this disclosure can be combined with one or more other aspects of this disclosure to form new aspects.

Various examples corresponding to aspects of this disclosure are described below:

Example 1 is a server device including one or more processors configured to: identify a home mobile network of a user equipment that attempts to roam in a visited mobile network comprising the server device, send, to a network function repository function, a service request that identifies the home mobile network, receive, from the network function repository function, a service request response that identifies a home subscriber service in the home mobile network and that identifies the home mobile network as a legacy network of the visited mobile network, retrieve, from the home subscriber service, subscriber information for the user equipment, and configure a roaming connection for the user equipment in the visiting mobile network.

In Example 2, the subject matter of Example 1 can optionally include that the one or more processors are configured to retrieve the subscriber information by: sending, on a legacy interface, a subscriber information request to the home subscriber service, and receiving, on the legacy interface, the subscriber information.

In Example 3, the subject matter of Example 2 can optionally include that the legacy interface is an S6a interface that uses a Diameter protocol.

In Example 4, the subject matter of any one of Examples 1 to 3 can optionally include that the one or more processors are configured to configure the roaming connection for the user equipment by establishing a home routing roaming connection for the user equipment with a packet gateway of the home mobile network, a radio access network of the visited mobile network, and a user-plane function of the visited mobile network.

In Example 5, the subject matter of any one of Examples 1 to 3 can optionally include that the one or more processors are configured to configure the roaming connection for the user equipment by establishing a local breakout roaming connection for the user equipment with a radio access network of the visited mobile network and a user-plane function of the visited mobile network.

In Example 6, the subject matter of any one of Examples 4 or 5 can optionally include that the one or more processors are configured to send control signaling to establish the home routing or local breakout roaming connection.

In Example 7, the subject matter of any one of Examples 1 to 6 can optionally include that the one or more processors are further configured to determine, based on the subscriber information, whether the home mobile network permits the user equipment to roam on the visited mobile network.

In Example 8, the subject matter of any one of Examples 1 to 6 can optionally include that the one or more processors are further configured to determine, based on a preconfigured operator policy, whether the visited mobile network permits the user equipment to roam on the visited mobile network.

In Example 9, the subject matter of any one of Examples 1 to 8 can optionally include that the home mobile network is a Fourth Generation, 4G, Evolved Packet Core, EPC, and that the visited mobile network is a Fifth Generation Core, 5GC.

Example 10 is a server device including one or more processors configured to: identify a home mobile network of a user equipment that attempts to roam in a visited mobile network comprising the server device, determine, based on preconfigured information in the server device, that the home mobile network is a legacy network of the visited mobile network, retrieve, from a home subscriber service in the home mobile network, subscriber information for the user equipment, and configure a roaming connection for the user equipment in the visiting mobile network.

In Example 11, the subject matter of Example 10 can optionally include that the one or more processors are configured to retrieve the subscriber information from the home subscriber service by: sending, on a legacy interface, a subscriber information request to the home subscriber service, and receiving, on the legacy interface, the subscriber information.

In Example 12, the subject matter of any one of Examples 10 or 11 can optionally include that the one or more processors are configured to configure the roaming connection for the user equipment by establishing a home routing roaming connection for the user equipment with a packet gateway of the home mobile network, a radio access network of the visited mobile network, and a user-plane function of the visited mobile network.

In Example 13, the subject matter of any one of Examples 10 or 11 can optionally include that the one or more processors are configured to configure the roaming connection for the user equipment by establishing a local breakout roaming connection for the user equipment with a radio access network of the visited mobile network, and a user-plane function of the visited mobile network.

In Example 14, the subject matter of any one of Examples 12 or 13 can optionally include that the one or more processors are configured to send control signaling to establish the home routing or local breakout roaming connection.

In Example 15, the subject matter of any one of Examples 10 to 14 can optionally include that the home mobile network is a Fourth Generation, 4G, Evolved Packet Core, EPC, and that the visited mobile network is a Fifth Generation Core, 5GC.

In Example 16, the subject matter of any one of Examples 10 to 15 can optionally include that the one or more processors are further configured to: send, to a network function repository function, a service discovery request that identifies the home mobile network and that indicates the home mobile network is a legacy network, receive, from the network function repository function, a service discovery response that identifies the home subscriber service.

Example 17 is a server device including one or more processors configured to: identify a home mobile network of a user equipment that attempts to roam in a visited mobile network comprising the server device, identify a home subscriber service in the home mobile network and determine that the home mobile network is a legacy network of the visited mobile network, determine that the server device does not support a legacy interface with the home subscriber service, and redirect the user equipment to a second server device in the visited mobile network or to a legacy core network of the visited mobile network.

In Example 18, the subject matter of Example 17 can optionally include that the server device is an access and mobility management function of the visited mobile network and that the second server device is a second access and mobility management function of the visited mobile network that supports a legacy interface with the home subscriber service.

In Example 19, the subject matter of any one of Examples 17 or 18 can optionally include that the one or more processors are configured to identify the home subscriber service in the home mobile network by referencing preconfigured information in the server device that identifies the home subscriber service as a component of the home mobile network.

In Example 20, the subject matter of any one of Examples 17 or 18 can optionally include that the one or more processors are configured to identify the home subscriber service in the home mobile network by sending, to a network function repository function, a service request that identifies the home mobile network, and receiving, from the network function repository function, a service request response that identifies a home subscriber service in the home mobile network and that identifies the home mobile network as a legacy network of the visited mobile network.

In Example 21, the subject matter of any one of Examples 17 to 20 can optionally include that the one or more processors are configured to redirect the user equipment to the second server device in the visited mobile network by sending, to a network function repository function or to a network slice selection function, a service request that requests information of an access and mobility management function that supports a legacy interface with the home subscriber service, receiving a service request response that identifies the second server device, and redirecting the user equipment to the second server device.

Example 22 is a method of handling roaming requests at a server device. The method may include: identifying a home mobile network of a user equipment that attempts to roam in a visited mobile network comprising the server device, sending, to a network function repository function, a service request that identifies the home mobile network, receiving, from the network function repository function, a service request response that identifies a home subscriber service in the home mobile network and that identifies the home mobile network as a legacy network of the visited mobile network, retrieving, from the home subscriber service, subscriber information for the user equipment, and configuring a roaming connection for the user equipment in the visiting mobile network.

In Example 23, the subject matter of Example 22 can optionally include that retrieving the subscriber information includes sending, on a legacy interface, a subscriber information request to the home subscriber service, and receiving, on the legacy interface, the subscriber information.

In Example 24, the subject matter of Example 23 can optionally include that the legacy interface is an S6a interface that uses a Diameter protocol.

In Example 25, the subject matter of any one of Examples 22 to 24 can optionally include that configuring the roaming connection for the user equipment includes: establishing a home routing roaming connection for the user equipment with a packet gateway of the home mobile network, a radio access network of the visited mobile network, and a user-plane function of the visited mobile network.

In Example 26, the subject matter of any one of Examples 22 to 24 can optionally include that configuring the roaming connection for the user equipment includes establishing a local breakout roaming connection for the user equipment with a radio access network of the visited mobile network and a user-plane function of the visited mobile network.

In Example 27, the subject matter of any one of Examples 25 or 26 can optionally include that configuring the roaming connection for the user equipment includes sending control signaling to establish the home routing or local breakout roaming connection.

In Example 28, the subject matter of any one of Examples 22 to 27 can optionally include that the method further includes determining, based on the subscriber information, whether the home mobile network permits the user equipment to roam on the visited mobile network.

In Example 29, the subject matter of any one of Examples 22 to 27 can optionally include that the method further includes determining, based on a preconfigured operator policy, whether the visited mobile network permits the user equipment to roam on the visited mobile network.

In Example 30, the subject matter of any one of Examples 22 to 29 can optionally include that the home mobile network is a Fourth Generation, 4G, Evolved Packet Core, EPC, and that the visited mobile network is a Fifth Generation Core, 5GC.

Example 31 is a method of handling roaming requests at a server device. The method may include: identifying a home mobile network of a user equipment that attempts to roam in a visited mobile network comprising the server device, determining, based on preconfigured information in the server device, that the home mobile network is a legacy network of the visited mobile network, retrieving, from a home subscriber service in the home mobile network, subscriber information for the user equipment, and configuring a roaming connection for the user equipment in the visiting mobile network.

In Example 32, the subject matter of Example 31 can optionally include that retrieving the subscriber information from the home subscriber service includes: sending, on a legacy interface, a subscriber information request to the home subscriber service, and receiving, on the legacy interface, the subscriber information.

In Example 33, the subject matter of any one of Examples 31 or 32 can optionally include that configuring the roaming connection for the user equipment includes establishing a home routing roaming connection for the user equipment with a packet gateway of the home mobile network, a radio access network of the visited mobile network, and a user-plane function of the visited mobile network.

In Example 34, the subject matter of any one of Examples 31 or 32 can optionally include that configuring the roaming connection for the user equipment includes establishing a local breakout roaming connection for the user equipment with a radio access network of the visited mobile network and a user-plane function of the visited mobile network.

In Example 35, the subject matter of any one of Examples 33 or 34 can optionally include that configuring the roaming connection for the user equipment includes sending control signaling to establish the home routing or local breakout roaming connection.

In Example 36, the subject matter of any one of Examples 31 to 35 can optionally include that the home mobile network is a Fourth Generation, 4G, Evolved Packet Core, EPC, and that the visited mobile network is a Fifth Generation Core, 5GC.

In Example 37, the subject matter of any one of Examples 31 to 35 can optionally include that the method further includes sending, to a network function repository function, a service request that identifies the home mobile network and that indicates the home mobile network is a legacy network, and receiving, from the network function repository function, a service response that identifies the home subscriber service.

Example 38 is a method of handling roaming requests at a server device. The method may include: identifying a home mobile network of a user equipment that attempts to roam in a visited mobile network comprising the server device, identifying a home subscriber service in the home mobile network and determine that the home mobile network is a legacy network of the visited mobile network, determine that the server device does not support a legacy interface with the home subscriber service, and redirecting the user equipment to a second server device in the visited mobile network or to a legacy core network of the visited mobile network.

In Example 39, the subject matter of Example 38 can optionally include that the server device is an access and mobility management function of the visited mobile network and wherein the second server device is a second access and mobility management function of the visited mobile network that supports a legacy interface with the home subscriber service.

In Example 40, the subject matter of any one of Examples 38 or 39 can optionally include that identifying the home subscriber service in the home mobile network includes referencing preconfigured information in the server device that identifies the home subscriber service as a component of the home mobile network.

In Example 41, the subject matter of any one of Examples 38 or 39 can optionally include that identifying the home subscriber service in the home mobile network includes sending, to a network function repository function, a service request that identifies the home mobile network, and receiving, from the network function repository function, a service request response that identifies a home subscriber service in the home mobile network and that identifies the home mobile network as a legacy network of the visited mobile network.

In Example 42, the subject matter of any one of Examples 38 to 41 can optionally include that redirecting the user equipment to the second server device in the visited mobile network includes sending, to a network function repository function or to a network slice selection function, a service request that requests information of an access and mobility management function that supports a legacy interface with the home subscriber service, receiving a service request response that identifies the second server device, and redirecting the user equipment to the second server device.

Example 43 is a computer readable medium storing instructions that, when executed by one or more processors, cause the one or more processors to perform the method of any one of Examples 22 to 42.

It should be noted that one or more of the features of any of the examples above may be combined with any one of the other examples.

In the following, various examples will be described in more detail.

The 3GPP has proposed several options for mobile network operators to deploy 5G technologies. Because many such operators have existing 3GPP 4G networks, they have already deployed 4G core networks (Evolved Packet Core (EPC)) and 4G radio access network (e.g., LTE) components. Thus, several of the 3GPP's options deploy a 5G NR radio access network by integrating it with 4G technology. Since these options integrate 5G NR and 4G, they are known as ‘non-standalone’ options.

FIG. 1 several of these non-standalone options according to some aspects. In deployment option 100, an LTE core network (EPC) 102 may serve as the core for an LTE radio access network 104 and an NR radio access network 106. In deployment option 110, a 5G core network (5GC) 112 may serve as the core for an LTE radio access network 104 and an NR radio access network 116 where the NR radio access network 116 acts as the master and LTE radio access network 104 acts as the secondary. In deployment option 120, a 5G core network (5GC) 122 may serve as the core network for an LTE radio access network 124 and an NR radio access network 126, where LTE radio access network 124 acts as the master and NR radio access network 126 acts as the secondary.

Mobile network operators may therefore have several options for deploying NR radio access networks alongside their existing LTE infrastructure as they transition from 4G to 5G. In addition to these non-standalone deployment options, the 3GPP has also proposed a standalone 5G deployment option. FIG. 2 shows an example according to some aspects. Here, deployment option 200 may deploy an NR radio access network 204 with a 5GC core network 202. There may not be any integration between LTE and NR in deployment option 200.

Though these different deployment options provide flexibility to mobile network operators, they may also lead to complications. For example, some deployment options may lead to problems for procedures like roaming. In traditional roaming, a UE with a certain home mobile network (termed home public land mobile network (HPLMN)) may connect to a visited mobile network (termed visited public land mobile network (VPLMN)). The visited mobile network may then query the HPLMN network for the UE's subscriber information and, after authenticating the UE, provide the UE with a network connection. With roaming, UEs may still have connectivity even when their home mobile networks are not available.

In 3GPP 4G roaming, the EPC of the visited mobile network may query the EPC of the home mobile network to retrieve the UE's subscriber information. This query uses the legacy 4G EPC interfaces, many of which use Diameter messaging protocol. For example, the mobility management entity (MME) in the visited mobile network may request the UE's subscriber information from the home subscriber service (HSS) in the home mobile network using the S6a interface. That S6a interface is one of several Diameter interfaces that the 3GPP has defined for EPC nodes to communicate with each other.

The 3GPP has also provided support for roaming between 5GC home and visited mobile networks. That support, however, is limited. For example, the 3GPP Release 15 and Release 16 standards only support roaming for 5GC inbound roaming users, meaning that a 5G UE with a 5GC home mobile network can roam on a 5GC visited mobile network. FIG. 3 shows an example of this 5GC inbound roaming according to some aspects. As shown in FIG. 3, a visiting UE 302 may attach to a visited 5GC core network 304 (5GC of a visited mobile network). Using the 3GPP's proposal, visited 5GC core network 304 may interface with visiting UE 302's home 5GC core network 306. Visited 5GC core network 304 may use this interface(s) to retrieve the subscriber information for visiting UE 302 and then configure a roaming connection for visiting UE 302. The interface(s) between visited 5GC core network 304 and home 5GC core network 306 may use the 3GPP 5G service based interface (SBI), which is a Hypertext Transfer Protocol (HTTP)-based interface(s).

While the 3GPP has provided a mechanism for UEs with 5GC home mobile networks to roam on 5GC visited mobile networks, the 3GPP standard has not specified an architecture for UEs with home EPC core networks to roam on visited 5GC core networks. For example, referring back to the 5G deployment options in FIG. 1, a visiting UE whose home mobile network operator uses deployment option 100 may not be able to roam on a mobile network that only has a 5GC core network (e.g., FIG. 1's deployment option 110 or FIG. 2's deployment option 200 in the visited mobile network).

This disclosure therefore provides mechanisms for inter-core network roaming. These mechanisms include an inter-core interfere architecture as well as procedures for the visited core network to identify a visiting UE's home mobile network, retrieve its subscriber information, and configure an appropriate roaming connection for the visiting UE. With this mechanism, UEs with home EPC core networks (e.g., EPC-only) may be able to roam on visited 5GC core networks. Users may therefore be able to enjoy 5G's superior bandwidth and flexibility even when roaming outside of their own home mobile networks.

FIG. 4 shows exemplary network architecture 400 according to some aspects. As shown in FIG. 4, visiting UE 416 may connect to the NR radio access network (NG-RAN) of a visited mobile network. The visited mobile network may have a 5GC core network, referred to herein as a visited 5GC core network. In some aspects, the 5GC core network may have only 5GC components, and no EPC components. As FIG. 4 shows, the visited 5GC core network may include 5GC network functions (NF) 406-412. NFs 406-412 may be core network nodes standardized by the 3GPP. For example, 3GPP TS 23.501 (Release 15/16) defines network repository function (NRF) 406 as a core network node that provides service registration and discovery services. Different NFs may query NRF 406 for NF services so they can discover each other. NRF 406 may therefore store NF profiles that it may provide in response to queries. The NF profiles may either be configured by the O&M system or NFs (408-412) itself registered with its NF profile with the NRF.

Access and management function (AMF) 408 may provide mobility management and access control for the 5GC core network. This may include registering an authenticating attached UEs, handling non-access stratum (NAS) signalling, and performing mobility management mobility management.

Session management function (SMF) 410 may handle session management for UEs connected to the 5GC core network. This may include managing protocol data unit (PDU) sessions and overseeing sessions with user plane function (UPF) 412.

UPF 412 may manage user-plane traffic flow between UEs and data networks (DNs). This may include packet routing and forwarding and Quality of Service (QoS) control.

Visiting UE 416 may have a home mobile network that uses an EPC core network (home EPC core network). As shown in FIG. 4, the home EPC core network may include at least home subscriber service (HSS) 402 and Serving/Packet Gateway (S/PGW) 404. Home subscriber service (HSS) may be an EPC node that stores the subscriber information for subscribers of the home mobile network. S/PGW 404 may be an EPC node that interfaces between the home mobile network and external packet data networks (PDNs) and route user-plane data to and from the home mobile network for its served UEs.

Because the home mobile network only deploys an EPC core network (e.g., as in deployment option 100 from FIG. 1), visited 5GC core network may not be able to use an existing 3GPP mechanism to configure a roaming connection for visiting UE 416. According to aspects of this disclosure, AMF 408 may therefore determine that visiting UE 416's home mobile network is EPC-only and then use an S6a (Diameter) interface to retrieve UE 416's subscriber information from HSS 402 in the home EPC core network. AMF 408 may then configure a roaming connection for visiting UE 416, such as a home routing (HR) roaming connection via the home EPC core network or a local breakout (LBO) roaming connection via the visited 5GC core network. In this way, visiting UE 416 may be able to roam on the visited 5GC core network even though its own home mobile network is EPC-only.

FIG. 5 shows exemplary message sequence chart 500 according to some aspects. Message sequence chart 500 describes a general procedure with which AMF 408 can discover and communicate with EPC NFs using NRF 406. This includes when AMF 408 communicates with, for example, HSS 402 in the home EPC core network. That example is described in greater detail in FIG. 6.

AMF 408 may initially start with a target NF that it wants to discover and communicate with. In this example, AMF 408 may not initially know whether the target NF is an EPC NF (e.g., any node in the EPC of another mobile network). As shown in FIG. 5, when attempting to communicate with a target NF, AMF 408 may first identify the HPMLN ID (ID for the home mobile network) of the target NF in stage 502. In one example, a visiting UE sends the HPLMN ID in the connection request (e.g. in Registration Request message) to AMF 408 in visited mobile network.

After identifying the HPLMN ID, AMF 408 may generate and send an NF service discovery request to NRF 406 in stage 504. With that NF service discovery request, AMF 408 may request information on the NF service, e.g., request information on the target NF. AMF 408 may include in the NF service discovery request the HPLMN ID and details on the target NF.

NRF 406 may receive and process the NF Service discovery request, thus identifying the HPLMN ID and NF details. NRF 406 may then, in stage 506, identify the address of the target NF and determine whether the target NF is an EPC component (an EPC indication). In some aspects, the address of the target NF may be a fully qualified domain name (FQDN). In some aspects, the operations and maintenance (O&M) system may have previously configured the FQDN and the EPC indication, and NRF 406 may perform stage 506 by referencing this preconfigured information. The EPC indication can be an explicit indication or implicit. For example, NRF 406 may provide the EPC indication in the form of an NF address (e.g., one or more bit(s) reserved in the NF address which identifies it is an EPC function or dedicated address(es) are reserved for the EPC function(s), which can identify the EPC function).

NRF 406 may then generate and send an NF Service discovery response in stage 508. NRF 406 may include the NF address (e.g., FQDN) and the EPC indication in the NF Service discovery response.

AMF 408 may receive and process the NF Service discovery response to identify the NF address with an EPC indication. Based on the EPC indication, AMF 408 may determine that the target NF is an EPC NF.

Alternatively, the AMF 408 may first identify the HPMLN ID (ID for the home mobile network) of the target NF in stage 502. Based on configuration in the AMF (e.g. local policy configured in the AMF), the AMF 408 determine that UE's home mobile network is an EPC network. For example, operations and maintenance (O&M) system may have previously configured the PLMN ID and the EPC indication in tAMF 408, e.g., preconfigured information specifying that HPLMN ID #1 is an EPC network and HPLMN ID #2 is an 5GC network, etc. Based on options, it is also possible that even if AMF 408 determines the home mobile network is an EPC network, AMF 408 will still FIG. 5's procedure to identify the NF address. In this case, the AMF may include an explicit EPC indication in the NF Service discovery request of stage 504, and NRF 406 may determine that the requested NF is an EPC NF based on that explicit EPC indication.

AMF 408 may have several different options once it identifies the target NF is an EPC NF. For example, if the AMF 408 supports an EPC interface with the target NF in its EPC core network, AMF 408 may use the EPC interface to communicate with the target NF. In one example, AMF 408 may use the EPC interface to retrieve subscriber information from a target HSS in a visiting UE's home mobile network.

In other examples, such as where AMF 408 does not support an EPC interface with the target NF, AMF 408 may redirect the visiting UE to use the visited mobile network's EPC. For instance, the visited mobile network may include both a 5GC and an EPC, an the visiting UE may be able to use the visited mobile network's EPC.

FIG. 5 therefore explains the general EPC NF discovery and selection for AMF 408. FIGS. 6-8 show exemplary message sequence charts specifically for inter-core network roaming according to some aspects. In these examples, the home mobile network may be a legacy network to the visited mobile network, such as a 4G network that is legacy to a 5G network. The home mobile network may therefore include a legacy core network (EPC vs. 5GC) which uses a legacy interface (e.g., based on the Diameter and other legacy protocol).

Since the home mobile network is a legacy network, the visited mobile network may use various aspects of this disclosure to provide inter-core network roaming to visiting UE 416. Starting with FIG. 6, exemplary message sequence chart 600 shows an example where AMF 408 acts like an EPC MME to configure a roaming connection for a visiting UE. As FIG. 6 shows, AMF 408 may first identify the HPLMN ID for visiting UE 416 in stage 602. For example, visiting UE 416 may connect to NG-RAN 414 (the NR radio access network) of the visited mobile network. Visiting UE 416 may then attempt to attach to the visited mobile network, which may include sending control signalling (e.g., a Registration request) to AMF 408 that includes its HPLMN ID.

After receiving the HPLMN ID, AMF 408 may attempt to retrieve the subscriber information for visiting UE 408. Like described for the general EPC NF communication procedure in FIG. 5, AMF 408 may not initially know that visiting UE 416's home mobile network is EPC-only. AMF 408 may use the same general procedure outlined in FIG. 5 to request NF service discovery from NRF 406. Specifically, AMF 408 may first send an NF Service discovery request to NRF 406 in stage 604. Specifically, AMF 408 may include the HPLMN ID and NF details of the target NF in the NF discovery request.

NRF 406 may receive the NF Service discovery request and identify the address (e.g., FQDN) of the target NF. NRF 406 may also determine, based on the HPLMN ID and the NF details, that the target NF is an EPC NF. For example, NRF 406 may determine that the target NF is HSS 402 in the EPC of the home mobile network. This information may be preconfigured in NRF 406 by O&M.

NRF 406 may then generate and send an NF service discovery response to AMF 408 in stage 608. The NF service discovery response may include the target NF's address and an EPC indication specifying that the target NF is an HSS.

Based on the NF service discovery response, AMF 408 may determine that the target NF is an EPC NF, and that it is an HSS, i.e., HSS 402. In this example, AMF 408 may be configured to use a legacy interface to communicate with HSS 402. For example, AMF 408 may be configured to communicate with HSS(s) with an S6a interface (e.g., Diameter). AMF 408 may thus determine to use the S6a interface in stage 610 of this example.

AMF 608 may then use the S6a interface to request visiting UE 416's subscriber information from HSS 402. As FIG. 6 shows, AMF 608 may generate and send a subscriber information request to HSS 402 with the S6a interface in stage 612. The subscriber information request may include visiting UE 416's ID.

HSS 402 may receive the subscriber information request and retrieve the subscriber information for visiting UE 416. HSS 402 may then generate and send a subscriber information response in stage 616. The subscriber information response may include visiting UE 416's subscriber information.

AMF 408 may receive the subscriber information request and then perform an attach procedure for visiting UE 416 in stage 416. For example, AMF 408 may act as an MME and perform 3GPP the attach procedure specified in 3GPP TS 23.401, clause 5.3.2.1, step 5a. AMF 408 may then configure the inter-core network roaming connection for visiting UE 416, described in detail later.

FIG. 7 shows another example of inter-core network roaming according to some aspects. In message sequence chart 700, AMF 408 may not support an EPC interface with HSS 402, and thus may not be able to request visiting UE's subscriber information over the S6a interface.

As message sequence chart 700 shows, AMF 408 and NRF 406 may perform stages 702-708 in the same manner as stages 602-608 from message sequence chart 600 in FIG. 6. However, in this example AMF 408 may determine in stage 710 that the target NF is HSS 402 (an EPC NF) and that AMF 408 does not support an EPC interface with EPC NFs. AMF 408 may therefore not be able to retrieve visiting UE 416's subscriber information from HSS 402.

Accordingly, in stage 712 AMF 408 may decide to identify an AMF that can support the EPC interface. In the example shown in FIG. 7, AMF 408 may generate and send an NF Service discovery request in stage 714 that requests an NF service for an AMF that supports EPC interfaces. NRF 406 may respond in stage 716 with an NF Service discovery response that identifies such an AMF. In another example, AMF 408 may request the identify of an AMF that supports EPC interfaces from the Network Slice Selection Function (NSSF; not explicitly shown in FIG. 4) of the visited mobile network. In these cases, AMF 408 may explicitly specify (indicate) that is requesting another AMF that supports EPC interfaces.

In any case, AMF 408 may identify another AMF that supports an S6a interface with HSS 402. AMF 408 may then redirect visiting UE 416 to that AMF in stage 716. For example, AMF 408 may send to visiting UE 416 control signalling that redirects visiting UE 416 to the other AMF. Alternatively, AMF 408 may redirect visiting UE 416 within the network (e.g., via signalling with NG-RAN 414 or communication signalling between AMFs) without visiting UE 416 knowing that it has been redirected to the other AMF.

The other AMF may then, for example, either obtain visiting UE 416's subscription information from HSS 402 or reject visiting UE 416's registration request. In an example where the other AMF obtains the subscription information from HSS 402, the other AMF may perform stages 602-616 of message sequence chart 600 in FIG. 6. By doing so, the other AMF may obtain visiting UE's subscription information from HSS 402, complete visiting UE 416's registration request, and configure an inter-core network roaming connection for visiting UE 416.

In the case where the other AMF rejects visiting UE 416's registration request, the other AMF may redirect the visiting UE to the visiting mobile network's EPC. That procedure is described below in stage 812 of message sequence chart 800 of FIG. 8.

FIG. 8 shows exemplary message sequence chart 800 according to some aspects. Like message sequence chart 700 in FIG. 7, message sequence chart 800 covers an example where AMF 408 does not support EPC interfaces. For example, instead of redirecting visiting UE 416 to another AMF, AMF 408 may reject visiting UE 416's registration request and then redirect visiting UE 416 to the visited mobile network's EPC.

As FIG. 8 shows, AMF 408 and NRF 406 may perform stages 802-810 in the same manner as stages 602-610 of FIG. 6's message sequence chart 600. AMF 408 may therefore determine that the target NF is an EPC NF in stage 810. Because AMF 408 does not support EPC interfaces, in stage 812 AMF 408 may reject visiting UE 416's registration request and redirect visiting UE 416 to the visited mobile network's EPC. AMF 408 may include an explicit indication in the rejection to visiting UE 416 to perform an attach procedure with an EPC in the visited mobile network. Thus, visiting UE 416 may not be able to attach the 5GC, and may not be able to use NG-RAN 414. Visiting UE 416 may instead attempt to attach to the visited mobile network's EPC, where it may use the 4G radio access network (e.g. E-UTRAN).

In some aspects, AMF 408 may be configured either to accept visiting UE 416's registration request or to redirect it based on operator policy. For example, AMF 408 may be preconfigured with operator policy that allows inter-core network roaming (where AMF 408 would use the procedure of message sequence chart 600 or 700) or with operator policy that forbids inter-core network roaming (where AMF 408 would use the procedure of message sequence chart 800). Thus, after receiving the NF service response from NRF 406 and/or determining that the target NF is an EPC NF, AMF 408 may determine whether to accept visiting UE 416's registration request based on the preconfigured operator policy.

In some aspects, visiting UE 416's home mobile network may allow or forbid UEs from performing inter-core network roaming. For example, HSS 402 may be preconfigured with these permissions. When AMF 408 (or another AMF, like in FIG. 7) requests visiting UE 416's subscriber information, HSS 402 may explicitly indicate in the subscriber information response that visiting UE 416 can or cannot perform inter-core network roaming e.g., with 5GC. AMF 408 may then decide whether to accept or reject and/or redirect to visiting EPC of visiting UE 416's registration request based on that explicit indication. For example, if the subscriber information response in 614 allows inter-core network roaming (e.g., allows visiting UE 416 to attach to 5GC mobile networks), AMF 408 may allow visiting UE 416's registration request. Conversely, if the subscriber information response in 614 forbids inter-core network roaming (e.g., allows visiting UE 416 to attach to 5GC mobile networks), AMF 408 may reject the registration request and/or redirect to the EPC in the visiting network.

In some aspects, once AMF 408 determines that a particular home mobile network (by HPLMN ID) supports EPC, AMF 408 may specify that information in later NF Service discovery requests. For example, AMF 408 may send an NF Service discovery request for the HPLMN ID of visiting UE 416's home mobile network, and the response from NRF 406 may specify that the home mobile network supports EPC. Then, if AMF 408 requests from NRF 406 an NF for that same HPLMN ID (e.g., for SGW or PGW selection in that home mobile network), AMF 408 may send an explicit request saying that it wants to discover an NF in the home mobile network and an express indication that it is requesting an EPC NF.

Accordingly, some examples in FIGS. 6-8 may provide inter-core network roaming for visiting UE 416, while other may reject visiting UE's 5GC registration request. If AMF 408 (or equivalently the other AMF from FIG. 7) accepts visiting UE 416's registration request, AMF 408 may configure a roaming connection for visiting UE 416. In some aspects, AMF 408 may configure the roaming connection as a home routing (HR) roaming connection, while in other aspects AMF 408 may configure the roaming connection as a local breakout (LBO) roaming connection. In some aspects, AMF 408 may decide whether to use HR or LBO e.g. based on visiting UE 416's subscription information.

This disclosure will use FIG. 4 to explain the HR and LBO roaming connection options. For HR roaming, the visited mobile network may route visiting UE 416's user data to and from visiting UE 416 via the home mobile network's EPC. For example, the visited mobile network may tunnel IP packets to and from visiting UE 416 and the internet via visiting UE 416's home mobile network.

In one HR roaming example using FIG. 4, AMF 408 then use a tunnelling interface with S/PGW 404 to route user data to and from visiting UE 416. That option is identified with identifier “IO #1” in FIG. 4. For example, AMF 408 may use an S11/S5-C interface with S/PGW 404 and establish S5-U to route data packets between S/PGW 404 and visiting UE 416 (via NG-RAN 414). S/PGW 404 may provide access to external networks like the Internet, thus providing an HR roaming connection to visiting UE 416. Since 3GPP has already standardized GPRS Tunnelling Protocol Control (GTP-C) protocol support for AMFs (for connected mode mobility from 5GC to EPC; 3GPP TS 23.501 and TS 23.502), AMF 408 may use GTP-C to exchange data with S/PGW 404 on the S11/S5-C interface. AMF 408 may configure this HR roaming connection by establishing a connection with S/PGW 404 over this interface.

In another HR roaming example using FIG. 4, SMF 410 may act like a Serving Gateway (SGW) and interface with S/PGW 404. That option is identified with identifier “IO #2” in FIG. 4. AMF 408 may configure the HR roaming connection by establishing routing link between visiting UE 416 and S/PGW 404. In the uplink direction, UPF 412 may receive visiting UE 416's user-pane packets (via NG-RAN 414, e.g. over an N3 interface) and forward them to S/PGW 404. UPF 412 may provide this forwarding with, for example, GTP-U tunnelling protocols over an S5-U interface with S/PGW 404. S/PGW 404 may then send these user-plane packets to external networks like the Internet. In the downlink direction, S/PGW 404 may receive user-plane packets from external networks and send them to UPF 412 (using the reverse link of the same interfaces). UPF 412 may then send the user-plane packets to visiting UE 416 (via NG-RAN 414). Control plane communication may then take place between AMF 408, SMF 410, and UPF 412. S/PGW 404 may perform both control and user plane functions (e.g., combined into one box).

AMF 408 may alternatively configure an LBO roaming connection for visiting UE 416. For LBO roaming, the visited mobile network may directly provide an external data connection to visiting UE 416 (e.g., without routing user-plane packets first to visiting UE 416's home mobile network). For example, UPF 412 may provide a connection to external data networks for visiting UE 416, and may route user-plane packets to and from visiting UE 416 on the path between (NG-RAN 414)-(UPF 412). AMF 408 may configure this LBO roaming connection by setting up NG-RAN 414 and UPF 412 to do this user-plane packet routing. The user-plane routing will be between NG-RAN 414 to UPF 412 to the internet, and the control plane routing will be between NG-RAN 414, AMF 408, SMF 410, and UPF 412.

In the examples of FIGS. 6-8 above, this disclosure explained that AMF 408 may discover HSS 402 (or other EPC NFs) by communicating with NRF 406. Other aspects may handle this subscriber information retrieval in different manners. For example, in some aspects AMF 408 may be preconfigured with the HSS information (e.g., via O&M), and may know in advance that certain mobile networks (by PLMN ID) are EPC. Thus, when AMF 408 identifies the HPLMN ID for visiting UE 416, AMF 408 may determine that the target NF is an EPC NF (e.g., an HSS) based on the preconfigured HSS information. AMF 408 may therefore directly decide to use an S6a interface (Diameter) to communicate with HSS 402 to retrieve visiting UE 416's subscriber information. Thus, in this example AMF 408 may not need to exchange NF service discovery requests and responses with NRF 406 to determine that the target NF is an EPC NF.

In another example, AMF 408 may still use NRF 406 to determine that the target NF is an EPC NF and that AMF 408 should use the S6a interface. However, instead of sending Diameter messages directly to HSS 402, AMF 408 may send the Diameter messages to a Service Communication Proxy (SCP; also known as the Delegated Discovery function). The SCP may then forward the message to HSS 402 on behalf of AMF 408 (e.g., forward a subscriber information request). The SCP may similarly forward messages from HSS 402 to AMF 408 (e.g., forward a subscriber information response). The general procedure for stages 610-616 in message sequence chart 600 will remain the same except for the SCP sitting between AMF 408 and HSS 402.

FIG. 9 shows another example for how AMF 408 can discover HSS 402 according to some aspects. Message sequence chart 900 shows two options of this. Like in the previous examples, AMF 408 may not initially know whether visiting UE 416's home mobile network has an EPC or 5GC core network. By default, AMF 408 may send a 5GC message to the SCP (e.g., Nudm_UECM_Registration) in stage 902.

The SCP may then determine that the target NF is an EPC NF (specifically, HSS) in stage 904. In some aspects, the SCP may be preconfigured (via O&M) with information identifying the HPLMN ID as an EPC. In other aspects, the SCP may query NRF 406 with an NF Service discovery request that requests information about the target NF (e.g., as in stages 504-508). The NF Service discovery response may then identify that the target NF is an HSS.

In the first option (“Option 1”), the SCP may translate the HTTP message to Diameter in stage 906. The SCP may then send a subscription information request (Diameter) to HSS 402 in stage 908 and response received from HSS 402 (in Diameter) is sent to AMF 408 (in HTTP messages). For example, in this case, the SCP seen by HSS 402 as a MME function and UDM as an AMF function. The protocol translation component (e.g., translation Diameter to HTTP (vice versa) or GTP to HTTP (vice versa) can be part of the SCP or can be outside of the SCP. If it is outside the SCP, then sends all the HTTP message to this component and this component translate to respective protocol and sends to the target NF directly or indirectly (via SCP).

In the second option (“Option 2”), the SCP may reject AMF 408's request in stage 910 (Nudm_UECM_Registration_Reject). Along with that rejection, the SCP may include HSS 402's address (e.g., FQDN) and an EPC indication specifying that the target NF is an EPC NF).

AMF 408 may thus determine that the target NF is an EPC NF based on the information in the rejection. AMF 408 may therefore decide to use Diameter messages to request and receive the subscription information for visiting UE 418. AMF 408 may generate and send a subscription information request (Diameter) in stage 912. In some aspects, AMF 408 may send the subscription information request directly to HSS 402. In other aspects, AMF 408 may send the subscription information to the SCP, which may forward the subscription information request to HSS 402. HSS 402 may respond by sending back the subscription information for visiting UE 418, either directly to AMF 408 or by routing it via the SCP.

With the aspects described above, a 5GC core network may support inter-core network roaming for visiting UEs whose home mobile networks only support EPC. Visiting UEs may therefore be able to use the visited mobile network's NR radio access network, thus enjoying higher data speeds and more flexibility.

In some aspects, the network functions (e.g., EPC and 5GC NFs/Services) described in this disclosure may be structurally configured like servers. For example, one or more of network functions 402-412 may include one or more processors configured to execute program code that defines its respective operations as described above. These one or more processors may retrieve that program code from a memory. In some aspects, one or more of network functions 402-412 may be implemented on a single processor or a co-located set of processors. In other aspects, one or more of network functions 402-412 may be implemented virtually, and may be executed across multiple separate processors using network function virtualization. From future perspective and could native design, some NFs may have one or more services. These services can run and manage independently in virtual or physical networks. It is therefore possible that there will no longer be NF concepts, but only network services (e.g., like IT companies). Aspects of this disclosure may also be implemented as software this manner. In some aspects, network functions 402-412 may include, or be executed on, one or more processors that work together with hardware logic circuitry (e.g., any type of specialized hardware, such as an application specific integrated circuit (ASIC)) to perform processing functions.

FIG. 10 shows an exemplary internal configuration of AMF 408. As shown in FIG. 10, AMF 408 may include memory 1002 and one or more processors 1004. Memory 1002 may store program code that one or more processors 1004 retrieve and execute. When one or more processors 1004 execute that program code, one or more processors 1004 may perform the operations of AMF 408 according to any aspect described herein. In some aspects, AMF 408 may be implemented virtually, such as where memory 1002 and/or one or more processors 1004 are split into different physical locations and operated using network virtualization.

While this disclosure has described specific aspects, it should be understood by those skilled in the art that various changes in form and detail may be made therein without departing from the spirit and scope of the aspects of this disclosure as defined by the appended claims. The scope is thus indicated by the appended claims and all changes which come within the meaning and range of equivalency of the claims are therefore intended to be embraced.

1. A server device comprising one or more processors configured to:
identify a home mobile network of a user equipment that attempts to roam in a visited mobile network comprising the server device;
send, to a network function repository function, a service request that identifies the home mobile network;
receive, from the network function repository function, a service request response that identifies a home subscriber service in the home mobile network and that identifies the home mobile network as a legacy network of the visited mobile network;
retrieve, from the home subscriber service, subscriber information for the user equipment; and
configure a roaming connection for the user equipment in the visiting mobile network.

2. The server device of claim 1, wherein the one or more processors are configured to retrieve the subscriber information by:
sending, on a legacy interface, a subscriber information request to the home subscriber service; and
receiving, on the legacy interface, the subscriber information,
wherein preferably the legacy interface is an S6a interface that uses a Diameter protocol.

3. The server device of claim 1, wherein the one or more processors are configured to configure the roaming connection for the user equipment by:
establishing a home routing roaming connection for the user equipment with a packet gateway of the home mobile network, a radio access network of the visited mobile network, and a user-plane function of the visited mobile network.

4. A server device comprising one or more processors configured to:
identify a home mobile network of a user equipment that attempts to roam in a visited mobile network comprising the server device;
determine, based on preconfigured information in the server device, that the home mobile network is a legacy network of the visited mobile network;
retrieve, from a home subscriber service in the home mobile network, subscriber information for the user equipment; and
configure a roaming connection for the user equipment in the visiting mobile network.

5. The server device of claim 4, wherein the one or more processors are configured to retrieve the subscriber information from the home subscriber service by:
sending, on a legacy interface, a subscriber information request to the home subscriber service; and
receiving, on the legacy interface, the subscriber information.

6. The server device of claim 4, wherein the one or more processors are configured to configure the roaming connection for the user equipment by:
establishing a home routing roaming connection for the user equipment with a packet gateway of the home mobile network, a radio access network of the visited mobile network, and a user-plane function of the visited mobile network, or
wherein the one or more processors are configured to configure the roaming connection for the user equipment by:
establishing a local breakout roaming connection for the user equipment with a radio access network of the visited mobile network, and a user-plane function of the visited mobile network.

7. A server device comprising one or more processors configured to:
identify a home mobile network of a user equipment that attempts to roam in a visited mobile network comprising the server device;
identify a home subscriber service in the home mobile network and determine that the home mobile network is a legacy network of the visited mobile network;
determine that the server device does not support a legacy interface with the home subscriber service; and
reject the user equipment and/or redirect the user equipment to a second server device in the visited mobile network or to a legacy core network of the visited mobile network.

8. The server device of claim 7, wherein the server device is an access and mobility management function of the visited mobile network and wherein the second server device is a second access and mobility management function of the visited mobile network that supports a legacy interface with the home subscriber service.

9. The server device of claim 7, wherein the one or more processors are configured to identify the home subscriber service in the home mobile network by:
referencing preconfigured information in the server device that identifies the home subscriber service as a component of the home mobile network, or
wherein the one or more processors are configured to identify the home subscriber service in the home mobile network by:
sending, to a network function repository function, a service request that identifies the home mobile network; and
receiving, from the network function repository function, a service request response that identifies a home subscriber service in the home mobile network and that identifies the home mobile network as a legacy network of the visited mobile network.

10. A method of handling roaming requests at a server device, the method comprising:
identifying a home mobile network of a user equipment that attempts to roam in a visited mobile network comprising the server device;
sending, to a network function repository function, a service request that identifies the home mobile network;
receiving, from the network function repository function, a service request response that identifies a home subscriber service in the home mobile network and that identifies the home mobile network as a legacy network of the visited mobile network;
retrieving, from the home subscriber service, subscriber information for the user equipment; and
configuring a roaming connection for the user equipment in the visiting mobile network.

11. A method of handling roaming requests at a server device, the method comprising:
identifying a home mobile network of a user equipment that attempts to roam in a visited mobile network comprising the server device;
determining, based on preconfigured information in the server device, that the home mobile network is a legacy network of the visited mobile network;
retrieving, from a home subscriber service in the home mobile network, subscriber information for the user equipment; and
configuring a roaming connection for the user equipment in the visiting mobile network.

12. The method of claim 11, wherein retrieving the subscriber information from the home subscriber service comprises:
sending, on a legacy interface, a subscriber information request to the home subscriber service; and
receiving, on the legacy interface, the subscriber information.

13. The method of claim 11, wherein configuring the roaming connection for the user equipment comprises:
establishing a home routing roaming connection for the user equipment with a packet gateway of the home mobile network, a radio access network of the visited mobile network, and a user-plane function of the visited mobile network.

14. A method of handling roaming requests at a server device, the method comprising:
identifying a home mobile network of a user equipment that attempts to roam in a visited mobile network comprising the server device;
identifying a home subscriber service in the home mobile network and determine that the home mobile network is a legacy network of the visited mobile network;
determining that the server device does not support a legacy interface with the home subscriber service; and
rejecting the user equipment and/or redirecting the user equipment to a second server device in the visited mobile network or to a legacy core network of the visited mobile network.

15. A computer readable medium storing instructions that, when executed by one or more processors, cause the one or more processors to perform the method of claim 10.

16. The server device of claim 2, wherein the one or more processors are configured to configure the roaming connection for the user equipment by:
establishing a home routing roaming connection for the user equipment with a packet gateway of the home mobile network, a radio access network of the visited mobile network, and a user-plane function of the visited mobile network.

17. The server device of claim 5, wherein the one or more processors are configured to configure the roaming connection for the user equipment by:
establishing a home routing roaming connection for the user equipment with a packet gateway of the home mobile network, a radio access network of the visited mobile network, and a user-plane function of the visited mobile network, or
wherein the one or more processors are configured to configure the roaming connection for the user equipment by:
establishing a local breakout roaming connection for the user equipment with a radio access network of the visited mobile network, and a user-plane function of the visited mobile network.

18. The server device of claim 8, wherein the one or more processors are configured to identify the home subscriber service in the home mobile network by:
referencing preconfigured information in the server device that identifies the home subscriber service as a component of the home mobile network, or
wherein the one or more processors are configured to identify the home subscriber service in the home mobile network by:
sending, to a network function repository function, a service request that identifies the home mobile network; and
receiving, from the network function repository function, a service request response that identifies a home subscriber service in the home mobile network and that identifies the home mobile network as a legacy network of the visited mobile network.

19. The method of claim 12, wherein configuring the roaming connection for the user equipment comprises:
establishing a home routing roaming connection for the user equipment with a packet gateway of the home mobile network, a radio access network of the visited mobile network, and a user-plane function of the visited mobile network.

20. A computer readable medium storing instructions that, when executed by one or more processors, cause the one or more processors to perform the method of claim 11.
